(19) United States
(12) Patent Application Publication
(10) Pub. No.: US 2011/0307145 A1
(43) Pub. Date: Dec. 15, 2011

(54) POWER GENERATION CONTROL APPARATUS AND POWER GENERATION CONTROL SYSTEM

(75) Inventor: Hirokazu Kato, Susono-shi (JP)

(73) Assignee: TOYOTA JIDOSHA KABUSHIKI KAISHA, Toyota-shi, Aichi-ken (JP)

(21) Appl. No.: 13/002,284

(22) PCT Filed: Apr. 27, 2010
(86) PCT No.: PCT/JP10/57496

§ 371 Date: Dec. 30, 2010

(51) Int. Cl. H02P 11/00

(52) U.S. Cl. 701/36

(57) ABSTRACT

A power generation control apparatus can switch, by controlling a power generation apparatus capable of generating power by power of a power source which makes a vehicle travel, between a first power generation control of mainly performing power generation at the time of deceleration of the vehicle while suppressing power generation at the time of acceleration of the vehicle in the case where normal travel of acceleration/deceleration travel is performed in a state where the power source operates and a second power generation control of mainly performing power generation at the time of acceleration of the vehicle while suppressing power generation at the time of deceleration of the vehicle in the case where acceleration/deceleration travel including coasting in which the vehicle travels in a state where the operation of the power source stops is performed. Consequently, power generation can be performed properly.

### FIELD

The present invention relates to a power generation control apparatus and a power generation control system.

### BACKGROUND

As a conventional power generation control apparatus or power generation control system, for example, Patent Literature 1 discloses an accessory drive device for driving accessories of a vehicle such as an alternator capable of generating power by power generated by an engine. When an engine automatic stop condition is satisfied during travel of a vehicle, the accessory drive device switches a state where the alternator is driven to generate power by the power generated by the engine to a state where the alternator is driven by inertia force at the time of deceleration of the vehicle to generate power.

### CITATION LIST

### Patent Literature

Patent Literature 1: Japanese Unexamined Patent Application Publication No. 2002-174305

### SUMMARY

### Technical Problem

With regard to the accessory drive device disclosed in the Patent Literature 1, further improvement is desired, for example, in terms of power generation control of the alternator as an accessory or the like.

The present invention has been achieved in consideration of the above circumstances and an object of the invention is to provide a power generation control apparatus and a power generation control system capable of properly generating power.

### Solution to Problem

To achieve the above object, a power generation control apparatus according to the present invention is capable of switching, by controlling a power generation apparatus capable of generating power by power of a power source which makes a vehicle travel, between a first power generation control of mainly performing power generation at the time of deceleration of the vehicle while suppressing power generation at the time of acceleration of the vehicle in the case where normal travel of acceleration/deceleration travel is performed in a state where the power source operates and a second power generation control of mainly performing power generation at the time of acceleration of the vehicle while suppressing power generation at the time of deceleration of the vehicle in the case where acceleration/deceleration travel including coasting in which the vehicle travels in a state where the operation of the power source stops is performed.

Further, in the power generation control apparatus as described above, the vehicle can shift to the coasting in accordance with an operation.

Further, in the power generation control apparatus as described above, the first power generation control and the second power generation control may be switched according to a driving state of the vehicle.

Further, in the power generation control apparatus as described above, the first power generation control and the second power generation control may be switched according to whether the coasting is performed or not in a predetermined travel interval.

Further, in the power generation control apparatus as described above, the first power generation control and the second power generation control may be switched when the coasting is performed in a deceleration travel interval of the vehicle.

Further, in the power generation control apparatus as described above, the first power generation control may be switched to the second power generation control at least after the first coating in a predetermined travel interval.

To achieve the object as described above, a power generation control system according to the present invention includes a power generation apparatus capable of generating power by power of a power source for making a vehicle travel, and a power generation control apparatus capable of switching, by controlling the power generation apparatus, between a first power generation control of mainly performing power generation at the time of deceleration of the vehicle while suppressing power generation at the time of acceleration of the vehicle in the case where normal travel of acceleration/deceleration travel is performed in a state where the power source operates and a second power generation control of mainly performing power generation at the time of acceleration of the vehicle while suppressing power generation at the time of deceleration of the vehicle in the case where acceleration/deceleration travel including coasting in which the vehicle travels in a state where the operation of the power source stops is performed.

### Advantageous Effects of Invention

The power generation control apparatus and the power generation control system according to the present invention have an effect that power generation can be performed properly by appropriately switching between first power generation control and second power generation control.

### BRIEF DESCRIPTION OF DRAWINGS

FIG. 1 is a schematic configuration diagram of a vehicle according to an embodiment.

FIG. 2 is a time chart for explaining an example of deceleration charging control by an ECU according to the embodiment.

FIG. 3 is a time chart for explaining an example of acceleration charging control by the ECU according to the embodiment.

FIG. 4 is a flowchart for explaining an example of control by the ECU according to the embodiment.

### DESCRIPTION OF EMBODIMENTS

Embodiments of a power generation control apparatus and a power generation control system according to the invention will be explained below in detail based on drawings. Note that the invention is by no means limited by the embodiments. Also, components in the following embodiment include a component, which may be easily replaced by one skilled in the art, or a substantially identical component.

### Embodiment

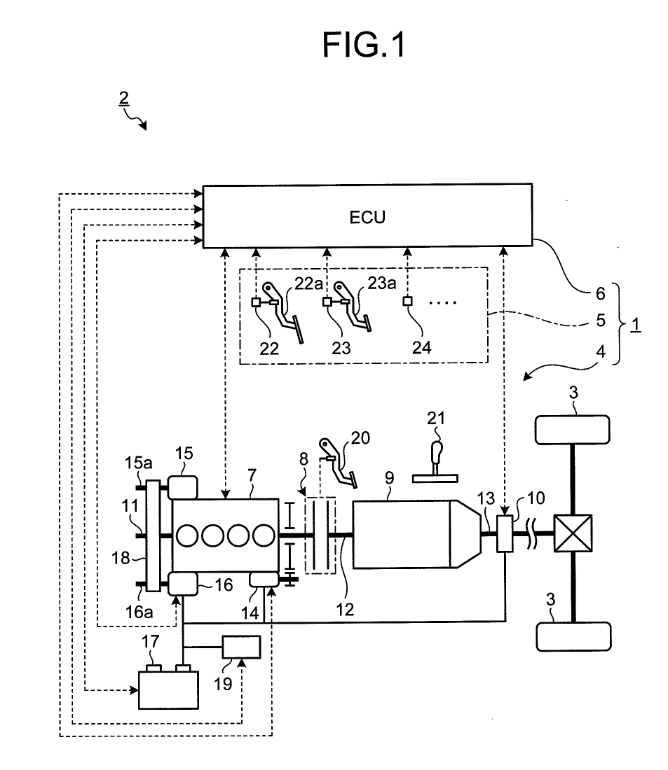

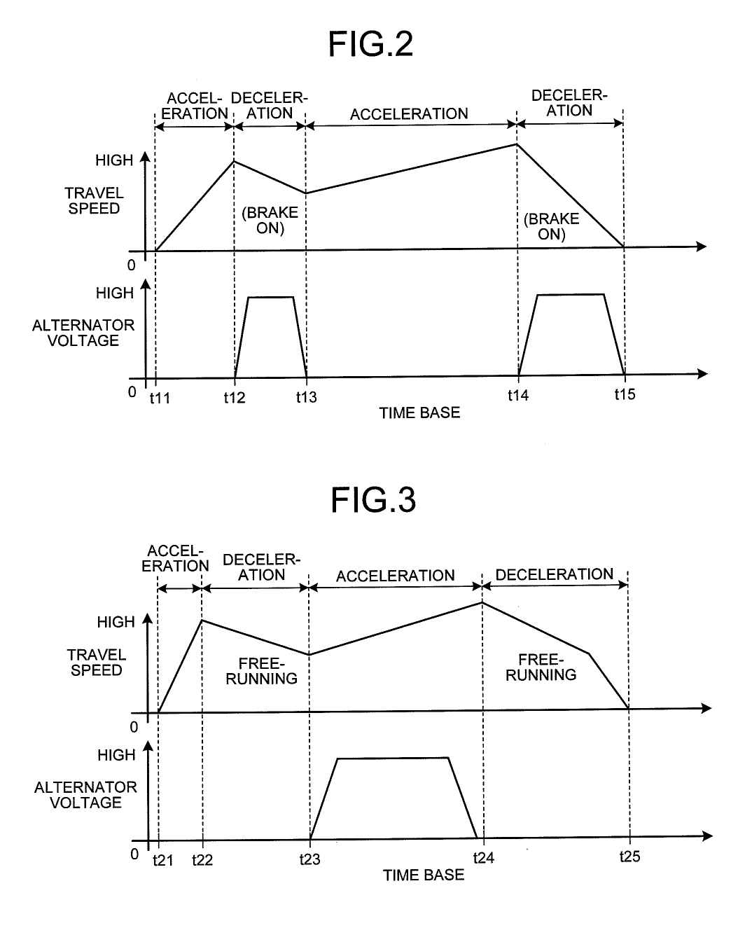

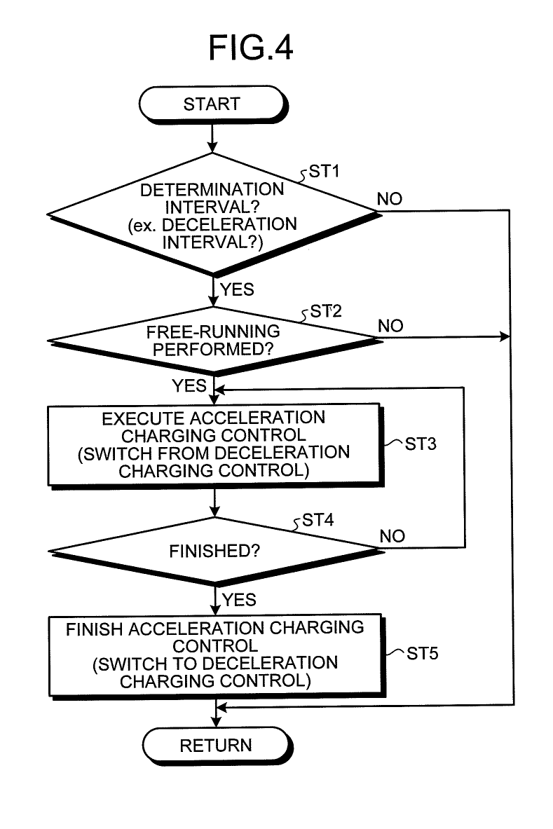

FIG. 1 is a schematic configuration diagram of a vehicle according to an embodiment. FIG. 2 is a time chart for explaining an example of deceleration charging control by an ECU according to the embodiment. FIG. 3 is a time chart for explaining an example of acceleration charging control by the ECU according to the embodiment. FIG. 4 is a flowchart for explaining an example of control by the ECU according to the embodiment.

A vehicle control system 1 as a power generation control system of the embodiment is, as shown in FIG. 1, a system mounted on a vehicle 2 and is used to control the vehicle 2. The vehicle 2 has, to drive forward by rotating driving wheels 3, as a power source for travel (motor), a power source for generating power to be acted on the driving wheels 3 of the vehicle 2, in this case, an engine 7 as an internal combustion engine for generating power to be acted on the driving wheels 3 of the vehicle 2 by consuming fuel. The vehicle 2 may be a so-called “hybrid vehicle” having, as a power source for travel, in addition to the engine 7, a motor generator or the like as an electric motor capable of generating power.

As shown in FIG. 1, the vehicle control system 1 of the embodiment has a drive device 4, a state detecting device 5, and an ECU 6 as a power generation control apparatus. The vehicle control system 1 is typically a system which can move to a control of stopping the operation of the engine 7 in accordance with an operation of the driver by the ECU 6 during travel of the vehicle 2 to make the vehicle 2 coast in a so-called free-running state, thereby improving fuel consumption.

The vehicle control system 1 described below is a system for controlling the components of the vehicle 2 and also a power generation control system for a vehicle having an alternator 16 as a power generator and controlling the alternator 16. That is, the vehicle control system 1 also has the function of the power generation control system for a vehicle. Specifically, in the following description, it is assumed that the vehicle control system 1 is also used as the power generation control system. However, the invention is not limited to the case. A vehicle control system and a power generation control system may be constructed separately. Similarly, the ECU 6 is a vehicle control apparatus for controlling the components of the vehicle 2 and also a power generation control apparatus for a vehicle controlling the alternator 16. That is, the ECU 6 also has the function of the power generation control apparatus for a vehicle. Specifically, in the following description, it is assumed that the ECU 6 is also used as a power generation control apparatus. The invention, however, is not limited to the case. A vehicle control apparatus and a power generation control apparatus may be constructed separately.

The drive device 4 has the engine 7 as an internal combustion engine and rotates the driving wheels 3 by the engine 7. More specifically, the drive device 4 includes the engine 7, a clutch 8, a transmission 9, and a regenerative device 10. In the drive device 4, a crankshaft 11 as an internal combustion engine output shaft of the engine 7 and a transmission input shaft 12 of the transmission 9 are connected via the clutch 8, and a transmission output shaft 13 of the transmission 9 is connected to the driving wheels 3 via a differential mechanism, a drive shaft, and the like.

The engine 7 is a power source for generating power to be acted on the driving wheels 3 of the vehicle 2 by consuming fuel, and is coupled to the driving wheels 3, and can generate an engine torque to be acted on the driving wheels 3. The engine 7 is a heat engine which burns the fuel to convert the energy of the fuel into a mechanical work and outputs the mechanical work. Examples of the engine 7 include a gasoline engine, a diesel engine, an LPG engine, and the like. The engine 7 makes the crankshaft 11 generate a mechanical power (engine torque) as the fuel burns and can output the mechanical power from the crankshaft 11 toward the driving wheels 3.

The vehicle 2 includes various accessories for indirectly assisting travel of the vehicle 2, such as a starter (motor) 14, a compressor 15 of an air conditioner (not shown) (so-called air-conditioner compressor), and the alternator 16. The starter 14 is provided for the engine 7 and driven by power supplied from a battery 17. An output of the starter 14 is transmitted via a power transmitter to the crankshaft 11, thereby starting rotating (clanking) the crankshaft 11 of the engine 7. The compressor 15 and the alternator 16 are provided for the engine 7, and drive shafts 15a and 16a are coupled to the crankshaft 11 via a power transmitter (a pulley, a belt, and the like) 18. With the configuration, the compressor 15 and the alternator 16 are drive interlockingly with the rotation of the crankshaft 11. For example, the alternator 16 is a power generator capable of generating power by the power of the engine 7 as the power source of driving the vehicle and can generate power during driving of the engine 7 (during rotation of the crankshaft 11) and accumulate the generated power in the battery 17. The vehicle 2 is provided with an accumulator (battery boost converter) 19 in addition to the battery 17, and the generated power can be stored in the accumulator 19.

The clutch 8 is a mechanism capable of cancelling engagement between the driving wheels 3 and the crankshaft 11 during the travel of the vehicle 2, and is provided between the engine 7 and the driving wheels 3 in a power transmission path. As the clutch 8, various known clutches can be used. The clutch 8 connects the crankshaft 11 and a transmission input shaft 12 so that they can be engaged with each other to allow power transmission as well as they can be disengaged from each other to prevent power transmission. By setting the crankshaft 11 as a rotating member on the engine 7 side and the transmission input shaft 12 as a rotating member on the driving wheel 3 side into an engagement state by the clutch 8, the power can be transmitted between the crankshaft 11 and the transmission input shaft 12, and a mechanical power from the crankshaft 11 can be transmitted toward the driving wheels 3. By setting the crankshaft 11 and the transmission input shaft 12 in a disengagement state by the clutch 8, transmission of power between the crankshaft 11 and the transmission input shaft 12 can be interrupted, and the mechanical power from the crankshaft 11 to the driving wheels 3 can be interrupted. The clutch 8 can be properly switched between the engagement state and the disengagement state via an intermediate half-engagement state in accordance with an operation (clutch operation) on a clutch pedal 20 by the driver.

The transmission 9 is provided between the clutch 8 and the driving wheels 3 in the power transmission path and can change speed of the rotation output of the engine 7 and output the resultant output. As the transmission 9, various known configurations can be used, such as a manual transmission (MT), a shifting automatic transmission (AT), a continuously variable transmission (CVT), a multimode manual transmission (MMT), a sequential manual transmission (SMT), and a dual clutch transmission (DCT). The transmission 9 can change the speed of the rotation power supplied to the transmission input shaft 12 at a predetermined transmission gear ratio, transmit the resultant power to a transmission output shaft 13, and output the power from the transmission output shaft 13 toward the driving wheels 3.

In the following description, unless otherwise noted, it is assumed that the transmission 9 is a manual transmission. The transmission 9 as a manual transmission has a plurality of gears (shift gears), and arbitrary one of the plurality of gears is selected according to an operation (shift operation) of a shift lever 21 by the driver. The transmission 9, by transmitting the power via the selected gear, changes the speed of the rotation power supplied to the transmission input shaft 12 in accordance with a transmission gear ratio assigned to the selected gear, and outputs the resultant rotation power from the transmission output shaft 13. The transmission 9 includes a so-called N (neutral) position. When the N position is selected by the shifting operation by the driver, the transmission 9 enters a state where there is no engagement in the gears between the transmission input shaft 12 and the transmission output shaft 13, which is a state where the engagement between the transmission input shaft 12 and the transmission output shaft 13 is cancelled. Therefore, when the N position is selected, even in a state where the clutch 8 is engaged, the transmission 9 enters a state where transmission of the mechanical power from the crankshaft 11 to the driving wheels 3 is interrupted, and the power from the engine 7 is not transmitted.

The regenerative device 10 regenerates kinetic energy during travel of the vehicle 2. The regenerative device 10 is a device having the function of a power generator of converting an input mechanical power to electric power. The regenerative device 10 can control whether the power is generated or not when the engine 7 stops, and is disposed in the power transmission path extending from the transmission output shaft 13 of the transmission 9 to the driving wheels 3. The regenerative device 10 can generate power by regeneration which is carried out when, for example, the transmission output shaft 13 or a rotary shaft such as a propeller shaft integrally rotatably coupled to the transmission output shaft 13 rotates by mechanical power. The power generated by the power generation is accumulated in an accumulating device such as the battery 17 or the accumulator 19. The regenerative device 10 can break (regenerative breaking) the rotation by rotational resistance which occurs in the transmission output shaft 13 or the rotary shaft coupled integrally rotatably to the transmission output shaft 13. As a result, the braking force can be given to the vehicle 2. The regenerative device 10 is constructed by, for example, a generator such as an alternator, a motor which can operate as a generator, or the like. Alternatively, the regenerative device 10 may be constructed by a rotating electrical machine or so-called motor generator having also the function of an electric motor for converting supplied power to mechanical power. The vehicle 2 has, in addition to the regenerative device 10, a hydraulic brake device (not shown) and the like.

The drive device 4 constructed as described above can transmit the power generated by the engine 7 to the driving wheels 3 via the clutch 8 and the transmission 9 or the like. As a result, a driving force [N] is generated on a ground contact face which comes into contact with the road surface of the driving wheel 3 and, with the force, the vehicle 2 can travel. At the time of regenerative control performed by the regenerative device 10, the drive device 4 can generate a regenerative torque as a negative torque at the transmission output shaft 13 or a rotary shaft integrally rotatably coupled to the transmission output shaft 13 by regeneration. As a result, in the vehicle 2, a braking force [N] is generated on a ground contact face of the driving wheel 3 which comes into contact with the road surface.

The state detecting device 5 detects a driving state of the vehicle 2 and includes various sensors and the like. The state detecting device 5 is electrically connected to the ECU 6 and can mutually transmit/receive information such as a detection signal, a drive signal, and a control instruction. The state detecting device 5 includes, for example, an acceleration sensor 22 for detecting an operation amount of an accelerator pedal 22a by the driver, a brake sensor 23 for detecting an operation amount of a brake pedal 23a by the driver, and a vehicle speed sensor 24 for detecting vehicle speed as travel speed of the vehicle 2. The operation amount of the accelerator pedal 22a is, for example, an accelerator opening and typically corresponds to a value according to the operation amount of an acceleration request operation requested to the vehicle 2 by the driver. The operation amount of the brake pedal 23a is, for example, a pedal effort of the brake pedal 23a and typically corresponds to a value according to an operation amount of a brake request operation requested to the vehicle 2 by the driver. The accelerator operation is an acceleration request operation on the vehicle 2 and is typically an operation of stepping on the accelerator pedal 22a of the driver. The braking operation is a brake request operation on the vehicle 2 and is typically an operation of stepping on the brake pedal 23a of the driver. The state where the accelerator operation and the brake operation are off is a state where the accelerator opening and the pedal effort are equal to or less than a predetermined value, typically, zero or less.

The ECU 6 controls driving of the components of the vehicle 2 such as the drive device 4 and the alternator 16. The ECU 6 is an electronic circuit using, as a main body, a known microcomputer including a CPU, a ROM, a RAM, and an interface. The ECU 6 is, for example, electrically connected to various sensors provided in the parts of the drive device 4 such as the engine 7. The ECU 6 is electrically connected to a fuel injector, an igniter, and a throttle valve device of the engine 7, the regenerative device 10, the battery 17, an inverter (not shown), various accessories such as the starter 14 and the alternator 16, the accumulator 19, and the like. For example, in the case where the transmission 9 is AT, CVT, MMT, SMT, DCT, or the like, the ECU 6 is connected to the clutch 8, the transmission 9, and the like via a hydraulic controller (not shown). To the ECU 6, electric signals corresponding to detection results from the various sensors are input. According to the input detection results, the ECU 6 outputs drive signals to the components and controls the driving of the components.

The ECU 6 starts the engine 7 or stops the operation during travel of the vehicle 2 and can switch between the operation state and the non-operation state of the engine 7. The state where the engine 7 is operated is a state where thermal energy generated by burning fuel in a combustion engine is output in the form of mechanical energy such as torque. On the other hand, the non-operation state of the engine 7, that is, the state where the operation of the engine 7 is stopped is a state where fuel is not burnt in the combustion chamber and the mechanical energy such as torque is not output.

As described above, the ECU 6 can shift to a control of setting a so-called free-running state of stopping consumption of the fuel in the engine 7 of the drive device 4 to set the non-operation state in accordance with a predetermined operation of the driver during travel of the vehicle 2 and to make the vehicle 2 coast. That is, the vehicle 2 can shift to coasting, i.e., free-running in accordance with an operation of the will of the driver. The ECU 6 of the embodiment stops supplying fuel to the combustion chamber of the engine 7 (fuel cut) in the free-running state of the vehicle 2 and executes power source stopping control of stopping generation of the power by the engine 7. By the operation, the ECU 6 can perform coasting which is free-wheeling through inertia by the inertia force of the vehicle 2 without outputting the mechanical power to the engine 7 of the drive device 4 or the like, and fuel consumption can be improved. That is, the free-running state of the vehicle 2 is a state where, in the driving wheels 3, the drive torque (drive force) by an engine torque generated by the engine 7 (or motor torque in the case where a motor generator is provided) and the brake torque (brake force) by engine brake torque generated by the engine 7 and a brake torque by the brake torque generated by the brake device do not act, and the vehicle 2 travels by the inertia force of the vehicle 2. It is executed in accordance with a predetermined free-running (coasting) operation by the driver.

In the case where the regenerative device 10 is mounted on the vehicle 2 as described above, in the free-running state of the vehicle 2, basically, the ECU 6 inhibits regeneration of the regenerative device 10 or suppresses power generation to the minimum, thereby minimizing the regenerative torque generated by the regenerating device 10. Consequently, the ECU 6 can suppress reduction of the effect of improving fuel consumption by using free-running during travel of the vehicle 2.

For example, in the case where the transmission 9 is an MT as in the embodiment, the predetermined free-running operation of the driver is a series of operations that the driver turns off the acceleration operation during travel of the vehicle 2, disengages the clutch 8 by clutching operation, selects the N position by the shifting operation and, after that, engages the clutch 8 again. When the driver performs the predetermined free-running operation during travel of the vehicle 2, the ECU 6 shifts to the control of stopping the consumption of the fuel in the drive device 4 to make the vehicle 2 coast and to set a free-running state. In the case where the transmission 9 is AT, CVT, MMT, SMT, DCT, or the like, the predetermined free-running operation of the driver is, for example, a series of operations that the driver turns off the acceleration operation or brake operation during travel of the vehicle 2 (for example, an operation of selecting the N range by the shifting operation may be added). The predetermined free-running operation of the driver is not limited to the above but may be, for example, an operation on a switch or a lever dedicated to the free-running operation.

The ECU 6 can shift to a control of setting an operation state by starting (restarting) consumption of the fuel in the engine 7 of the drive device 4 to set the vehicle 2 to a normal travel state in accordance with a predetermined operation of the driver during free-running of the vehicle 2. The normal travel state of the vehicle 2 is a travel state where, in the driving wheels 3, a drive torque (driving force) by an engine torque generated by the engine 7 (or a motor torque in the case where the motor generator is provided) or a braking torque (braking force) by an engine brake torque generated by the engine 7, a regenerative torque generated by the regenerative device 10, and a brake torque generated by the brake device acts, and is executed in accordance with a predetermined free-running cancelling operation by the driver. The predetermined free-running cancelling operation of the driver is, for example, an operation of performing an operation of changing a gear to a predetermined gear during the free-running of the vehicle 2, an operation of turning on the acceleration operation, or a brake operation.

As described above, the ECU 6 functions as a power generation control apparatus for a vehicle for controlling the alternator 16. The ECU 6 can execute a power generation control of controlling the alternator 16, further, a power generation control of controlling a power generation amount of the alternator 16. The alternator 16 operates, as described above, when the mechanical power is transmitted from the engine 7 via the power transmitter 18 and the like and can control whether power is generated or not when the crankshaft 11 of the engine 7 rotates and power is output. The alternator 16 is, for example, constructed by a three-phase AC generator including a stator coil provided for a stator and having a three-phase winding wire and a field coil provided for a rotor and positioned on the inside of the stator coil. By rotating the field coil in a current passing state, the alternator 16 makes the stator coil generate induced power, converts an induced current (three-phase AC current) to a direct current by a rectifier, and outputs it. The alternator 16 has a voltage regulator, controls field current flowing in the field coil by the voltage regulator according to a control signal input from the ECU 6, and adjusts the induced power generated in the stator coil and the power generation amount.

In the vehicle control system 1 of the embodiment, for example, the ECU 6 properly switches the power generation control of the alternator 16 in accordance with the travel state of the vehicle 2, thereby enabling power generation to be properly performed according to the travel state as a whole. The ECU 6 of the embodiment can properly perform power generation by switching the control mode of the power generation control of the alternator 16 between the case where normal travel of acceleration/deceleration travel is performed in an operation state where the engine 7 operates and the case where coasting of travel in a non-operation state where the operation of the engine 7 stops, that is, acceleration/deceleration travel including free-running is performed.

Concretely, the ECU 6 of the embodiment can switch between deceleration charging control as the first power generation control and acceleration charging control as the second power generation control by controlling the alternator 16.

The normal travel is, more concretely, travel using, as a travel power, power generated by the engine 7 in the operation state where the engine 7 operates. On the other hand, the free-running (coasting) is, as described above, travel in a state where consumption of fuel in the engine 7 stops in a non-operation state where the operation of the engine 7 stops. The free-running is typically travel in a state where engagement of the crankshaft 11 and the driving wheels 3 is cancelled in the clutch 8 or the transmission 9 and the rotation of the crankshaft 11 stops. At the time of free-running, typically, the speed of the vehicle 2 is reduced by travel resistance caused by, for example, the road surface, atmosphere, and the like.

In the case where the normal travel is performed, the deceleration charging control is typically power generation control executed when the normal travel is often performed. The deceleration charging control is control of charging the battery 17 and the accumulator 19 by suppressing the power generation at the time of acceleration of the vehicle 2 and mainly performing the power generation at the time of deceleration of the vehicle 2. When the normal travel is often performed, the ECU 6 executes the deceleration charging control as the power generation control. The ECU 6 executes the deceleration charging control by making the power generation amount at the time of acceleration of the vehicle 2 relatively small and making the power generation amount at the time of deceleration relatively large by controlling the alternator 16. Typically, in the deceleration charging control, the ECU 6 sets the power generation amount by the alternator 16 at the time of acceleration of the vehicle 2 to zero. In the deceleration charging control, the ECU 6 may generate power by the regenerative device 10 at the time of deceleration of the vehicle 2.

The acceleration charging control is power generation control executed in the case where acceleration/deceleration travel including free running is performed, typically, in the case where the free-running is often performed. The acceleration charging control is control of charging the battery 17 and the accumulator 19 by suppressing the power generation at the time of deceleration of the vehicle 2 and mainly performing the power generation at the time of acceleration of the vehicle 2. When the free running is often performed, the ECU 6 executes the acceleration charging control as the power generation control. The ECU 6 executes the acceleration charging control by making the power generation amount at the time of deceleration of the vehicle 2 relatively small and making the power generation amount at the time of acceleration relatively large by controlling the alternator 16. Typically, in the acceleration charging control, the ECU 6 sets the power generation amount by the alternator 16 at the time of deceleration of the vehicle 2 to zero.

In the vehicle control system 1 constructed as described above, in the case where the normal travel is often used, the ECU 6 executes the deceleration charging control. Therefore, the power generation by the alternator 16 is suppressed at the time of acceleration of the vehicle 2 and, on the contrary, the power generation amount by the alternator 16 is increased at the time of deceleration accompanying a brake operation or the like of the driver. As a result, in the state where the engine 7 operates, the vehicle control system 1 can collect the kinetic energy as power by the alternator 16 at the time of deceleration of the vehicle 2 and charge the battery 17 and the accumulator 19 while assuring efficient acceleration performance at the time of acceleration of the vehicle 2. Therefore, the battery 17 and the accumulator 19 are maintained in a proper accumulation state, and fuel consumption can be improved.

On the other hand, in the vehicle control system 1, in the case where free-running is often performed, the operation of the engine 7 basically stops at the time of deceleration of the vehicle 2, in other words, at the time of free-running, so that power cannot be generated by the alternator 16. In the vehicle control system 1, to suppress reduction of the effect of improving fuel consumption by using the free-running, preferably, regeneration of the regenerative device 10 is inhibited at the time of deceleration of the vehicle 2 or power generation is suppressed to the minimum.

At this time, in the vehicle control system 1, in the case where free-running is often performed, the ECU 6 switches the mode of the power generation control and executes the acceleration charging control. Therefore, at the time of deceleration of the vehicle 2, in other words, at the time of free-running, power generation by the alternator 16 is suppressed. On the other hand, at the time of acceleration of the vehicle 2, the power generation amount by the alternator 16 is increased. As a result, the vehicle control system 1 can suppress reduction in the effect of improving the fuel consumption by using the free running at the time of deceleration of the vehicle 2 and can generate power by using the power of the engine 7 by the alternator 16 at the time of acceleration of the vehicle 2 in which the engine 7 operates. Therefore, even in the case where the free-running is often used, regeneration by the regenerative device 10 is inhibited at the time of deceleration of the vehicle 2, the power generation is suppressed to the minimum, or the regenerative device 10 is not provided, the vehicle control system 1 can generate power by the alternator 16 at the time of acceleration of the vehicle 2 and charge the battery 17 and the accumulator 19. Thus, the battery 17 and the accumulator 19 can be maintained in a proper accumulation state.

For example, in the vehicle control system 1, when it is assumed that either the deceleration charging control or the acceleration charging control is continuously executed in both of the case where the normal travel is often used and the case where the free-running is often used, there is the possibility that the fuel consumption deteriorates as a result.

However, by switching the deceleration charging control and the acceleration charging control between the case where the normal travel is often used and the case where the free-running is often used, in the alternator 16, the vehicle control system 1 can generate power mainly at the time of deceleration in the case where the normal travel with the brake operation is often used and can generate power mainly at the time of acceleration in the case where the free-running is often used. Consequently, the vehicle control system 1 can optimize the relation between the fuel consumption improving effect and the power generation period by the alternator 16 in accordance with the travel state of the vehicle 2.

In the vehicle 2 in which free-running can be performed by the intension of the driver, the ECU 6 switches between the deceleration charging control and the acceleration charging control in accordance with the driving state of the vehicle 2. For example, the ECU 6 detects coasting, that is, the acceleration/deceleration travel including free-running in accordance with the driving state of the vehicle 2 and separates the case where the free-running is performed and the case where the normal travel accompanying the brake operation is performed. The driving state of the vehicle 2 includes, for example, an operation state of the driver on the vehicle 2 and the travel state of the vehicle 2. The ECU 6 determines, for example, that the free-running is performed according to the operation state of the driver and the travel state of the vehicle 2, and typically determines that the present travel state is a travel state often using free-running.

For example, the ECU 6 switches between the deceleration charging control and the acceleration charging control according to the presence or absence of free-running (coasting) in a predetermined travel interval. For example, the ECU 6 detects that free-running is performed, typically, the present travel state is a travel state often using free-running in accordance with the presence or absence of free-running in a predetermined travel interval. Concretely, the ECU 6 detects that, for example, the normal travel is performed in the case where the brake operation is turned on by the driver in a deceleration travel interval of the vehicle 2 as a predetermined travel interval, typically, that the present travel state is the travel state often using the normal travel. On the contrary, the ECU 6 detects that, for example, the possibility of free-running is high in the case where the brake operation by the driver is “off” (or maintained “off”) in a deceleration travel interval of the vehicle 2 as a predetermined travel interval and free-running is performed actually, typically, that the present travel state is the travel state often using the free-running.

That is, in the case where free-running is performed in a predetermined travel interval, for example, the deceleration travel interval of the vehicle 2, the ECU 6 switches between the deceleration charging control and the acceleration charging control. For example, when free-running is performed in the deceleration travel interval of the vehicle 2, the ECU 6 predicts that the possibility that free-running is performed again in the next deceleration travel interval is high, and detects that the present travel state is a travel state often using free-running. The ECU 6 detects that the present travel state is the travel state often using free-running until it is determined that the present driving state of the vehicle 2 is changing or has changed. Whether the present driving state of the vehicle 2 is changing or has changed or not can be determined according to, for example, whether so-called IG-OFF is performed or not, acceleration of the vehicle 2 has been finished or not, or whether one trip (a period or interval during which a vehicle shifts from vehicle stop state to a travel state and then back to the vehicle stop state) of the vehicle 2 has finished or not.

In this case, for example, in the case where free-running is performed in the deceleration travel interval (predetermined travel interval) of the vehicle 2, the ECU 6 switches the power generation control from the deceleration charging control to the acceleration charging control and executes the acceleration charging control. For example, in the case where the vehicle 2 stops (for example, in the case where the vehicle speed is continued at a preset stop-determination vehicle speed or less for a predetermined period which is set in advance), the ECU 6 switches the power generation control from the acceleration charging control to the deceleration charging control and executes the deceleration charging control again.

Next, an example of the deceleration charging control and the acceleration charging control will be described with reference to the time charts of FIGS. 2 and 3. In both of FIGS. 2 and 3, the horizontal axis refers to time base, and the vertical axis indicates travel speed (vehicle speed) and alternator voltage as the voltage of the alternator 16. As shown in FIG. 2, when the brake operation is performed (ON) by the driver in a travel interval, for example, a deceleration travel interval in one trip from start time t11 of the vehicle 2 to stop time t15, the ECU 6 executes the deceleration charging control in a travel interval corresponding to one trip from the start time t11 to the stop time t15. The ECU 6 suppresses power generation (sets the power generation amount to zero in this case) at the time of acceleration of the vehicle 2, that is, in a period from time t11 to time t12 and a period from time t13 to time t14, and mainly generates power at the time of deceleration of the vehicle 2, that is, in a period from time t12 to time t13 and a period from time t14 to time t15.

On the other hand, as shown in FIG. 3, when the brake operation by the driver is not performed (OFF) and free-running is performed in a travel interval, for example, a deceleration travel interval in one trip from start time t21 of the vehicle 2 to stop time t25, the ECU 6 executes the acceleration charging control in a travel interval corresponding to one trip from the start time t21 to the stop time t25. The ECU 6 suppresses power generation (sets the power generation amount to zero in this case) at the time of next deceleration of the vehicle 2, that is, in a period from time t24 to time t25 and mainly generates power at the time of acceleration of the vehicle 2, that is, in a period from time t23 to time t24.

As a result, also in the vehicle 2 in which free-running can be performed freely by the intention of the driver, the vehicle control system 1 can properly switch between the deceleration charging control executed in the case where the normal travel is performed and the acceleration charging control executed in the case where deceleration travel including free-running is performed by the ECU 6. Thus, power generation can be properly performed in accordance with the travel state in the alternator 16.

In the vehicle control system 1, in the case of FIG. 3, strictly speaking, the deceleration charging control is continued without being switched to the acceleration charging control until the first free-running is actually performed in the deceleration travel interval. That is, in the vehicle control system 1, until the time point when the first free-running is performed in the deceleration travel interval, the deceleration charging control is continued. For example, the power generation control, mainly, power generation at the time of deceleration is performed by the alternator 16 or the regenerative device 10. That is, in the case of the example of FIG. 3, after at least the first free-running (coasting) at the time of the deceleration in the predetermined travel interval is performed, the ECU 6 switches the power generation control from the deceleration charging control to the acceleration charging control. Accordingly, according to the presence/absence of the first free-running, the ECU 6 can determine whether free-running is performed in the predetermined travel interval, that is, whether the free-running is performed often or not. Using actual execution of free-running in the deceleration travel interval as a trigger, the ECU 6 can switch the power generation control from the deceleration charging control to the acceleration charging control. Therefore, power generation according to the travel state can be performed more reliably. For example, until the power generation control is actually switched to the acceleration charging control, the power generation can be effectively performed at the time of deceleration.

The method of detecting that the acceleration/deceleration travel including free-running is performed, typically, that the present travel state is the travel state often using free-running is not limited to the above. It is sufficient for the ECU 6 to detect that the acceleration/deceleration travel including free-running is performed by various methods. The predetermined travel interval for determining the presence or absence of free-running is not limited to the deceleration travel interval but may be, for example, a stationary travel interval or the like. For example, when free-running is performed even once in a travel interval corresponding to one trip as a predetermined travel interval, or when free-running is performed more than a predetermined number of times which is set in advance, the ECU 6 may detect the following one trip as a travel interval in which free-running is performed (often used). That is, for example, when free-running is performed even once in a travel interval corresponding to one trip as a predetermined travel interval, or when free-running is performed more than a predetermined number of times which is set in advance, the ECU 6 may switch between the deceleration charging control and the acceleration charging control in the following one trip. The ECU 6 may detects free-running on the basis of whether or not a predetermined travel interval in which the vehicle 2 is traveling at present is a travel interval in which free-running was often used in the past from past travel history by using a GPS, a navigation device, or the like. That is, the ECU 6 may switch between the deceleration charging control and the acceleration charging control on the basis of the past travel history.

Next, an example of the control performed by the ECU will be described with reference to the flowchart of FIG. 4. The control routine is repeatedly executed in control cycles of a few ms to tens ms.

First, the ECU 6 determines whether the present travel interval of the vehicle 2 is a determination interval (predetermined travel interval), for example, a deceleration travel interval or not on the basis of various information obtained from the state detecting device 5 (ST1).

In the case where the present travel interval is determined as the determination interval (deceleration travel interval) (Yes in ST1), the ECU 6 determines whether free-running is performed or not on the basis of the various information obtained from the state detecting device 5 (ST2). The ECU 6 determines whether free-running is performed or not, for example, on the basis of whether the free-running operation is performed by the driver or not or on the basis of the state of the engine 7, the clutch 8, the transmission 9, or the like during the travel of the vehicle 2.

In the case where it is determined that free-running is performed (Yes in ST2), the ECU 6 switches the power generation control from the deceleration charging control to the acceleration charging control and executes the acceleration charging control (ST3). When the acceleration charging control is being executed at this time, the ECU 6 continues executing the acceleration charging control.

Next, the ECU 6 determines whether the interval of executing the acceleration charging control is finished or not (ST4). The ECU 6 determines whether the interval of executing the acceleration charging control is finished or not based on, for example, whether IG-OFF is performed or not, whether acceleration of the vehicle 2 is finished or not, whether the vehicle 2 is stopped or not (one trip is finished or not), or the like.

In the case where it is determined that the interval of executing the acceleration charging control is not finished (No in ST4), the ECU 6 returns to ST3 and repeatedly executes the subsequent processes. In the case where it is determined that the interval of executing the acceleration charging control is finished (Yes in ST4), the ECU 6 switches the power generation control from the acceleration charging control to the deceleration charging control, finishes the acceleration charging control, returns to the deceleration charging control (ST5), finishes the present control cycle, and shifts to the next control cycle.

When it is determined that the present interval is not the determination interval (deceleration travel interval) in ST1 (No in ST1) or when it is determined in ST2 that there is no free-running (No in ST2), the ECU 6 finishes the present control cycle and shifts to the next control cycle.

The ECU 6 according to the embodiment described above can switch, by controlling the alternator 16 capable of generating power by power of the engine 7 which makes the vehicle 2 travel, between the declaration charging control (first power generation control) of mainly performing power generation at the time of deceleration of the vehicle 2 while suppressing power generation at the time of acceleration of the vehicle 2 in the case where the normal travel of acceleration/deceleration travel is performed in a state where the engine 7 operates and the acceleration charging control (second power generation control) of mainly performing power generation at the time of acceleration of the vehicle 2 while suppressing power generation at the time of deceleration of the vehicle 2 in the case where acceleration/deceleration travel including free-running (coasting) in which the vehicle travels in a state where the operation of the engine 7 stops is performed. The vehicle control system 1 according to the above-described embodiment includes the alternator 16 capable of generating power by power of the engine 7 for making the vehicle 2 travel and the ECU 6. Therefore, the vehicle control system 1 and the ECU 6 can perform power generation properly in accordance with the driving state by switching the power generation control between the deceleration charging control and the acceleration charging control in accordance with the drive state of the vehicle 2.

The power generation control apparatus and the power generation control system according to the foregoing embodiment of the invention are not limited to the foregoing embodiment but can be variously changed within the scope of claims.

Although the vehicle control system 1 in which the ECU 6 can shift to the control of stopping the operation of the engine 7, making the vehicle 2 coast, and setting a free-running state in accordance with an operation of the driver during travel of the vehicle 2 has been described above, it can shift to a control of automatically setting the free-running state in accordance with the driving state of the vehicle 2 under control of the ECU 6, not according to the operation of the driver.

Although the vehicle control system 1 has the regenerative device 10 in the above description, the invention is not limited to the configuration but the regenerative device 10 may not be provided. Although the power source is the engine 7 in the above description, the invention is not limited to the configuration. For example, the power source may be a motor generator or the like.

Although the engagement of the crankshaft 11 and the driving wheels 3 is cancelled by the clutch 8 or the transmission 9 in the free-running state of the vehicle 2 and the rotation of the crankshaft 11 stops in the above description, the invention is not limited to the case. In the free-running state of the vehicle 2, basically, it is sufficient to set the engine 7 in a non-operation state and the vehicle 2 enters a coasting state. For example, a state where the engagement of the crankshaft 11 and the driving wheels 3 is maintained and the crankshaft 11 rotates along the driving wheels 3, that is, a brake torque generated by an engine brake torque acts on the driving wheels 3 may be set.

### INDUSTRIAL APPLICABILITY

The power generation control apparatus and the power generation control system according to the present invention as described above are suitable as a power generation control apparatus and a power generation control system mounted on various vehicles.

### REFERENCE SIGNS LIST

1 VEHICLE CONTROL SYSTEM (POWER GENERATION CONTROL SYSTEM)
2 VEHICLE
3 DRIVING WHEELS
6 ECU (POWER GENERATION CONTROL APPARATUS)
7 ENGINE (POWER SOURCE)
8 CLUTCH
9 TRANSMISSION
16 ALTERNATOR (POWER GENERATION APPARATUS)
17 BATTERY
19 ACCUMULATOR

1. A power generation control apparatus capable of switching, by controlling a power generation apparatus capable of generating power by power of a power source which makes a vehicle travel, between a first power generation control of mainly performing power generation at the time of deceleration of the vehicle while suppressing power generation at the time of acceleration of the vehicle in the case where normal travel of acceleration/deceleration travel is performed in a state where the power source operates and a second power generation control of mainly performing power generation at the time of acceleration of the vehicle while suppressing power generation at the time of deceleration of the vehicle in the case where acceleration/deceleration travel including coasting in which the vehicle travels in a state where the operation of the power source stops is performed.

2. The power generation control apparatus according to claim 1, wherein the vehicle can shift to the coasting in accordance with an operation.

3. The power generation control apparatus according to claim 1, wherein the first power generation control and the second power generation control are switched according to a driving state of the vehicle.

4. The power generation control apparatus according to claim 1, wherein the first power generation control and the second power generation control are switched according to whether the coasting is performed or not in a predetermined travel interval.

5. The power generation control apparatus according to claim 1, wherein the first power generation control and the second power generation control are switched when the coasting is performed in a deceleration travel interval of the vehicle.

6. The power generation control apparatus according to claim 1, wherein the first power generation control is switched to the second power generation control at least after the first coating in a predetermined travel interval.

7. A power generation control system comprising:
a power generation apparatus capable of generating power by power of a power source for making a vehicle travel; and
a power generation control apparatus capable of switching, by controlling the power generation apparatus, between a first power generation control of mainly performing power generation at the time of deceleration of the vehicle while suppressing power generation at the time of acceleration of the vehicle in the case where normal travel of acceleration/deceleration travel is performed in a state where the power source operates and a second power generation control of mainly performing power generation at the time of acceleration of the vehicle while suppressing power generation at the time of deceleration of the vehicle in the case where acceleration/deceleration travel including coasting in which the vehicle travels in a state where the operation of the power source stops is performed.

8. The power generation control apparatus according to claim 2, wherein the first power generation control and the second power generation control are switched according to a driving state of the vehicle.

9. The power generation control apparatus according to claim 2, wherein the first power generation control and the second power generation control are switched according to whether the coasting is performed or not in a predetermined travel interval.

10. The power generation control apparatus according to claim 3, wherein the first power generation control and the second power generation control are switched according to whether the coasting is performed or not in a predetermined travel interval.

11. The power generation control apparatus according to claim 2, wherein the first power generation control and the second power generation control are switched when the coasting is performed in a deceleration travel interval of the vehicle.

12. The power generation control apparatus according to claim 3, wherein the first power generation control and the second power generation control are switched when the coasting is performed in a deceleration travel interval of the vehicle.

13. The power generation control apparatus according to claim 4, wherein the first power generation control and the second power generation control are switched when the coasting is performed in a deceleration travel interval of the vehicle.

14. The power generation control apparatus according to claim 2, wherein the first power generation control is switched to the second power generation control at least after the first coating in a predetermined travel interval.

15. The power generation control apparatus according to claim 3, wherein the first power generation control is switched to the second power generation control at least after the first coating in a predetermined travel interval.

16. The power generation control apparatus according to claim 4, wherein the first power generation control is switched to the second power generation control at least after the first coating in a predetermined travel interval.

17. The power generation control apparatus according to claim 5, wherein the first power generation control is switched to the second power generation control at least after the first coating in a predetermined travel interval.
